(19) United States
(12) Patent Application Publication
(10) Pub. No.: US 2017/0159808 A1
(43) Pub. Date: Jun. 8, 2017

(54) DEVICE FOR ADJUSTING A MOVEMENT OF AN OPERATING ELEMENT FOR AN AUTOMATIC TRANSMISSION OF A VEHICLE, METHOD FOR PRODUCING SAME, AND SHIFTING DEVICE FOR SHIFTING AN AUTOMATIC TRANSMISSION OF A VEHICLE

(71) Applicant: ZF Friedrichshafen AG, FRIEDRICHSHAFEN (DE)

(72) Inventors: Yanik KÜHNE, Diepholz (DE); Michael VOELZ, Diepholz (DE); Sascha ROSENTRETER, Espelkamp (DE)

(73) Assignee: ZF Friedrichshafen AG, FRIEDRICHSHAFEN (DE)

(21) Appl. No.: 15/316,338

(22) PCT Filed: Apr. 27, 2015
(86) PCT No.: PCT/EP2015/059018

§ 371 Date: Dec. 6, 2016

(30) Foreign Application Priority Data
Jun. 6, 2014 (DE) DE102014210828.4

(51) Int. Cl. F16H 61/24; F16H 59/02

(52) U.S. Cl. CPC F16H 61/24; F16H 59/0204; F16H 59/0208; F16H 2061/243

(57) ABSTRACT

A device for the adjustment of a movement of an operating element for an automatic transmission of a vehicle. The device comprises an engaging contour for defining of at least one shift position of the operating element along a motion path of the operating element and a contact surface. The locking contour is thereby formed at least partially of a hard material with a first elasticity, and the contact surface is formed from a soft material with a second elasticity. The second elasticity of the soft material is hereby greater than the first elasticity of the hard material.

### BACKGROUND

1. Technical Field

The present invention relates to a device for adjusting a movement of an operating element for an automatic transmission of a vehicle, a shifting device for shifting an automatic transmission of a vehicle, as well as a method for producing a device for adjusting a movement of an operating element for an automatic transmission of a vehicle.

2. Background Information

A locking device in the vehicle sector, respectively automobile sector can be used in connection with an automatic transmission for a guide and haptic position back coupling of a gear lever, respectively selector lever. DE 10 2012 206 992 A1 reveals a locking device.

### BRIEF SUMMARY

In this context, the present invention provides an improved device for adjusting a movement of an operating element for an automatic transmission of a vehicle, an improved shifting device for shifting an automatic transmission of a vehicle, as well as an improved method for producing a device for adjusting a movement of an operating element for an automatic transmission of a vehicle according to the main claims. Advantageous design examples are the result of the sub claims and the following description.

According to design examples of the present invention, especially a sound-insulated locking mechanism, respectively a structure-borne sound-insulated locking mechanism may be provided for an operating element of a vehicle transmission. The locking device can hereby be shapeable or be shaped from two materials with different elasticities to have a highly elastic material on at least one contact surface of the locking device.

According to design examples of the present invention, noise emissions of a shifting of the transmission can advantageously be reduced through an improved structure-borne sound insulation due to soft-material contact surfaces, for example. Consequently, both an operating comfort of a transmission can be increased and interfering noise in a vehicle interior can thus be reduced. An assembly, respectively assembly operation for acoustic isolating elements can furthermore be omitted. A number of required components can additionally be reduced. The result is also short tolerance chains.

A device for adjusting a movement of an operating element for an automatic transmission has a locking contour to define at least one shift position of the operating element along a movement path of the operating element and a contact surface, whereby the locking contour is at least partially formed from a hard material with a first elasticity, and the contact surface is formed from a soft material with a second elasticity, and whereby the second elasticity of the soft material is greater than the first elasticity of the hard material.

The device may be used for adjusting a movement of an operating element of a machine, such as a vehicle, for example. The vehicle can be a motor vehicle, particularly a road vehicle like a passenger car or a truck. Alternatively, the vehicle can be a rail vehicle or an aircraft, for example. The device can a be an apparatus or a part of an apparatus of the vehicle. The device may be described as a locking device. The device may be shaped in one piece from the hard material and the soft material. The locking contour can present a partial section of the device. The locking device can be arranged, shaped, and formed to guide the operating element, and to additionally or alternatively, enable a resistance, respectively a sensory, particularly haptic feedback with regard to a movement or shift position of the operating element during shifting operations. The operating element can be a gear lever of the automatic transmission that may be manually operated by a driver of the vehicle, for example, to select different drive positions, respectively gears of the automatic transmission. The movement of the operating element may take place between shift positions, respectively positions P for parking, N for neutral, R for reversing, and D for driving, as well as from D into a gate or a shifting gate, for example. The movement of the operating element may also be done between a rest position and at least one deviating position. The contact surface can be an external surface of the device. The contact surface may be formed in one piece or comprise at least two partial sections arranged spaced apart from each other.

According to one design example, the contact surface may comprise an operating element contact surface in a partial section of the locking contour arranged in at least one switch position of the operating element. The locking contour can hereby be partially formed from the hard material and from the soft material in the at least one partial section. The at least one partial section can be arranged to one shift position of the operating element, which can be a rest position or position D, for example. Such a design example offers the advantage that a selective position damping is enabled with an acoustic decoupling between the locking contour and the operating element.

The device may also comprise a soft material section shaped from the soft material, and the locking contour partially shaped from the hard material can be shaped spanning the soft material section. The soft material section can thereby be shaped to function as a sound absorption mat, or an insulating underlay for the locking contour. The external surface of the device is thus shaped from the hard material at least partially in the area of the locking contour. Such a design example offers the advantage that an improved damping, respectively a dampened position of the locking contour is enabled. An improved acoustic damping during the movement of the operating element can thus be achieved.

The device may furthermore have at least one fastening section to fasten the device to a support device by means of a fastening element. The contact surface may hereby comprise a fastening contact surface of the at least one fastening section. Such a fastening contact surface may be shaped to be in mechanical contact in a state fastened to the support device with the support device, and to additionally or alternatively be in a fastening element. Such a design example provides the advantage that an acoustic decoupling between the support device, respectively a housing and the device as well as the locking device is enabled, so that a structure-borne sound insulation can furthermore be improved.

The device may additionally have at least one stop section for the mechanical limiting of a movement of the operating element along the movement path. The contact surface may thereby comprise a stop contact surface of the at least one stop section. The at least one stop section may be shaped from the soft material at least in part. By means of the at least one stop section, at least one end position may thus be defined during a movement of the operating element. The definition of the at least one end position may additionally take place by means of a geometric shape of the locking contour. Such a design example provides the advantage that an acoustically decoupled locking mechanism can be provided with integrated stop dampers for the operating element.

An area of the device comprising the soft material can particularly be shaped connecting, and additionally or alternatively in one piece. A connecting, respectively single-piece soft material volume can thus comprise the operating element contact surface, the soft material section, the fastening contact surface, and additionally or alternatively the stop contact surface. Such a design example provides the advantage that an assembly, respectively assembly operation can be omitted for otherwise customary decoupling elements, and that a number of required components for a shifting device can be reduced.

A shifting device for shifting an automatic transmission of a vehicle has an operating element with a locking element, whereby the shifting device has a design example of the previously listed device for adjusting a movement of the operating element, whereby the stop element of the operating element is arranged movable when moving the operating element along the locking contour of the device.

In connection with the shifting device, a design example of the previously listed device for adjusting may be used, respectively utilized beneficially for adjusting a movement of the operating element. An acoustic decoupling between the locking contour and the locking element, respectively an acoustic decoupling between the locking element and the operating element can thus be achieved. The locking element can be a locking dowel, or a locking pin or the like. The locking element can be arranged in an assembled condition of the shifting device attached against the locking contour of the device. The locking device may be preloaded in a direction towards the locking contour of the device. The shifting device may furthermore comprise a support device that the device may be attachable to or attached to for adjustment.

A method for producing a device for adjusting a movement of the operating element for an automatic transmission of a vehicle comprises the following steps:

Shaping of a locking contour to define at least one switch position of the operating element along a movement path of the operating element at least partially from a hard material with a first elasticity; and

Shaping of a contract surface of the device from a soft material with a second elasticity that is greater than the first elasticity.

By performing the procedure, a design example of the previously listed device for adjusting may be produced in an advantageous manner.

According to one design example, in the process of shaping the contact surface, a fastening contact surface of at least one fastening section may be shaped from the soft material for fastening the device to a support device in at least one partial section of the locking contour arranged to a shifting position of the operating element by means of a fastening element, and at least or alternatively a stop contact surface of at least one stop section for the mechanical limiting of a movement of the operating element along the movement path. The device may furthermore be shaped during the steps of the shaping by that the locking contour shaped at least partially from the hard material spans a soft material section. Such a design example provides the advantage that a locking device with an improved structure-borne sound insulation, as well as possibly with a selective position damping and/ or stop damper may be provided.

The steps of the shaping may also be performed by executing a two-component injection molding process. The device may therefore be shaped with the steps of the molding through injection molding from the hard material and the soft material. The soft material of the device can thereby be shaped connected and additionally or alternatively in one piece. Such a design example provides the advantage that the device is especially inexpensive to produce by means of two-component injection molding.

### BRIEF DESCRIPTION OF THE DRAWINGS

The invention is clarified in an exemplary manner by means of the enclosed drawings. The following is shown:

FIG. 1 is a perspective view of a device for adjusting in accordance with a design example of the present invention;

FIG. 2 is a side view of the device for adjusting from FIG. 1;

FIG. 3 is a top view of the device for adjusting from FIG. 1 resp. FIG. 2;

FIG. 4 is a sectional view of a shifting device according to a design example of the present invention;

FIG. 5 is a sectional view of the shifting device from FIG. 4 in a different shifting status;

FIG. 6 is a flow chart of a manufacturing process according to a design example of the present invention;

FIG. 7 is a schematic representation of a vehicle with a shifting device according to a design example of the present invention; and

FIGS. 8A to 8F are representations of a device for adjusting according to another design example of the present invention.

### DETAILED DESCRIPTION OF THE DRAWINGS AND THE PRESENTLY PREFERRED EMBODIMENTS

Same or similar reference signs are used in the following description of preferred design examples of the present invention for the elements represented in the different figures, and which seem similar, whereby a repeated description of these elements will be omitted.

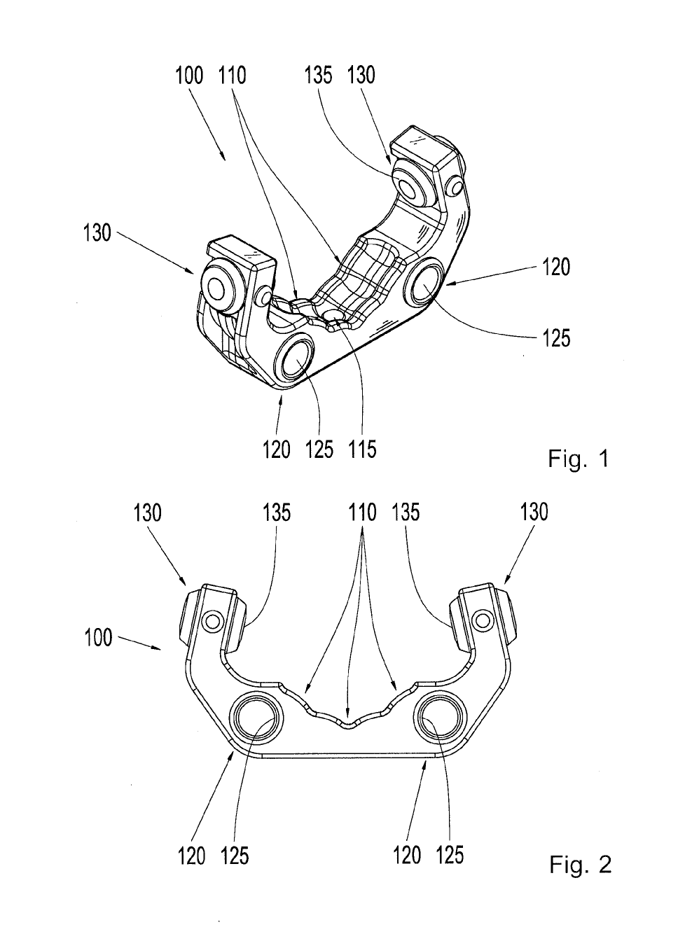

FIG. 1 shows a perspective view of a device 100 for adjusting a movement of an operating element for an automatic transmission of a vehicle according to a design example of the present invention. What is hereby shown in FIG. 1 of the device 100, respectively locking device, is a locking contour 110, an operating element contact surface 115, and a merely exemplary number of two fastening sections 120, fastening contact surfaces 125, stop sections 130, and stop contact surfaces 120, each.

The device 100 is shaped as a single-piece body from a hard material and a soft material. The hard material thereby has a first elasticity, and the soft material has a second elasticity. The second elasticity is greater than the first elasticity. The device 100, except for the operating element contact surface 115, the fastening contact surfaces 125, and the stop contact surfaces 135, is shaped from the hard material.

The device 100 is hereby shaped elongated and with a trough-shaped, respectively U-similar, laterally open profile. The locking contour 110, the operating element contact surface 115, the fastening sections 120, and the fastening contact surfaces are arranged in a floor area of the trough-shaped profile of the device 100. The stop sections 130 and the stop contact surfaces 135 are arranged in side-wall areas of the trough-shaped profile of the device 100. In accordance with the design example of the present invention represented in FIG. 1, the sidewall areas of the trough-shaped profile are shaped overhanging with respect to the bottom area of the trough-shaped profile.

The locking contour 110 is arranged, respectively shaped in the bottom area of the trough-shaped profile of the device 100. The locking contour 110 is thereby formed as a longitudinal trough with a rounded cascading ground in the bottom area. The locking contour 110, in particular, has a multiply kinked, rough V-shaped longitudinal profile. According to the design example of the present invention represented in FIG. 1, the locking contour 110 except for the operating element contact surface 115 is shaped from the hard material with the first elasticity. The locking contour 115 is formed to at least define a shift position of the operating element along one movement path of the operating element. The locking contour 110 is also shaped to guide a partial section of the operating element along the locking contour 110 during the movement of the operating element. The partial section of the operating element is hereby moveable along the locking contour 110.

The locking contour 110 has the operating element contact surface 115. The operating element contact surface 115 is shaped from the soft material with the second elasticity. The operating element contact surface 115 is thereby essentially arranged centrally with reference to a longitudinal extension measurement of the locking contour 110. To be precise, the operating element contact surface 115 is assigned to a partial section of the locking contour 110 arranged in a shift position of the operating element. The switch position is a resting position or center, respectively normal position of the operating element, for example. The operating element contact surface 115 is thus shaped to enable a selective position damping of the operating element, here on a center position, whereby more positions are possible. The locking contour 110 can optionally also have at least one more operating element contact surface 115 in at least one more partial section that has at least one more switch position assigned to it.

One first fastening section 120 is shaped in the device in a first end region of the locking contour 110. One second fastening section 120 is shaped in the device in a second end region of the engaging contour 110 facing away from the first end region. The locking contour 110 is thus arranged between the fastening sections 120. The fastening sections 120 are shaped as passage openings through the device 100. Longitudinal extension axes of the fastening sections 120 hereby extend transversely to a longitudinal extension axis of the locking contour 110. The fastening sections 120 are shaped to fasten the device 100 to a support device by means of fastening elements.

The fastening contact surfaces 125 are arranged extending in the passage openings of the fastening sections 120. The fastening contact surfaces 125 are thereby shaped from the soft material. One first fastening contact surface 125 is arranged in the first of the fastening sections 120, and a second fastening contact surface 125 is arranged in the second of the fastening sections 120. The fastening contact surfaces 125 are formed to be in physical, respectively mechanical contact with the support device and/ or the fastening elements in a state of the device 100 attached to the support device. In other words, the fastening sections 120 thus represent inclusion sections, respectively inclusion points in the support device, respectively a housing, whereby a structure-borne sound insulation of the device 100 through the soft material, respectively a soft component of the fastening contact surfaces 125 can be realized.

The stop sections 130 are arranged, respectively shaped in the sidewall areas of the trough-shaped profile, respectively in end areas of the device 100. A first stop section 130 is arranged in an area of a first end of the device 100 and a second of the stop sections 130 is arranged in the area of a second end of the device 100 opposing the first end. The fastening sections 120 and the locking contour 110 are therefore arranged between the stop sections 130. The stop sections 130 are shaped to mechanically limit a movement of the operating element along the movement path. In other words, the stop sections 130 function as stop dampers for the operating element, respectively a gear lever.

The stop contact surfaces 135 are part of the contact sections 130. The stop contact surfaces 135 are hereby arranged facing the locking contour 110. In other words, the stop contact surfaces 135 are facing an inside of a trough formed by the device 110. In particular, the stop contact surfaces 135 are therefore essentially also arranged facing each other. The stop contact surfaces 135 are thereby formed from the soft material. The first stop section 130 has a first stop contact surface 135, and the second of the stop sections 130 has a second stop contact surface 135. The stop contact surfaces 135 are shaped to be in mechanical contact with the operating element in stop positions of the operating elements that are arranged to ends of the movement paths of the same.

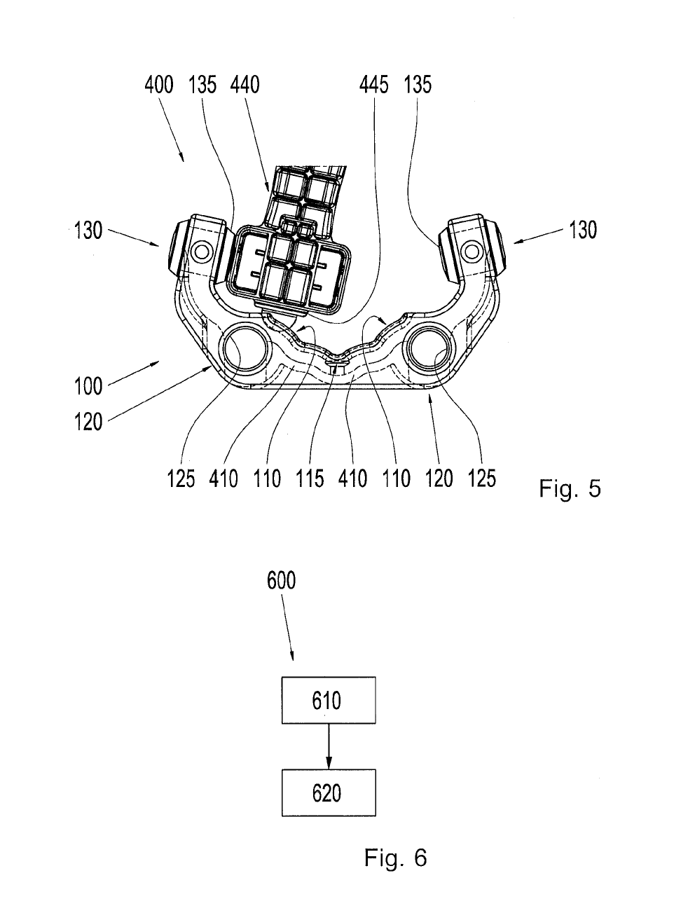

Even if it is not explicitly shown in FIG. 1, but is noticeable by reference of FIG. 4, respectively FIG. 5, it must be noted that the soft material of the device 100 is shaped connected and/ or in one piece according to one design example, and that the locking contour 110 that is partially shaped from the hard material spans across a soft material section.

According to one design example, an area of the device 100 comprising the soft material can comprise only the operating element contact surface 115, only at least one of the fastening contact surfaces 125, only at least one of the stop contact surfaces 135, or only the soft material section, or also any combination of some or all of these features 115, 125, 135.

FIG. 2 shows a side view of the device 100 from FIG. 1. An operating element contact surface is hereby covered in the representation due to the trough shape 110 of the locking contour 110 by a sidewall of the same. The multiply kinked, rough V-shaped longitudinal profile of the locking contour 110 and the trough shape of the device 100 can be recognized in FIG. 2.

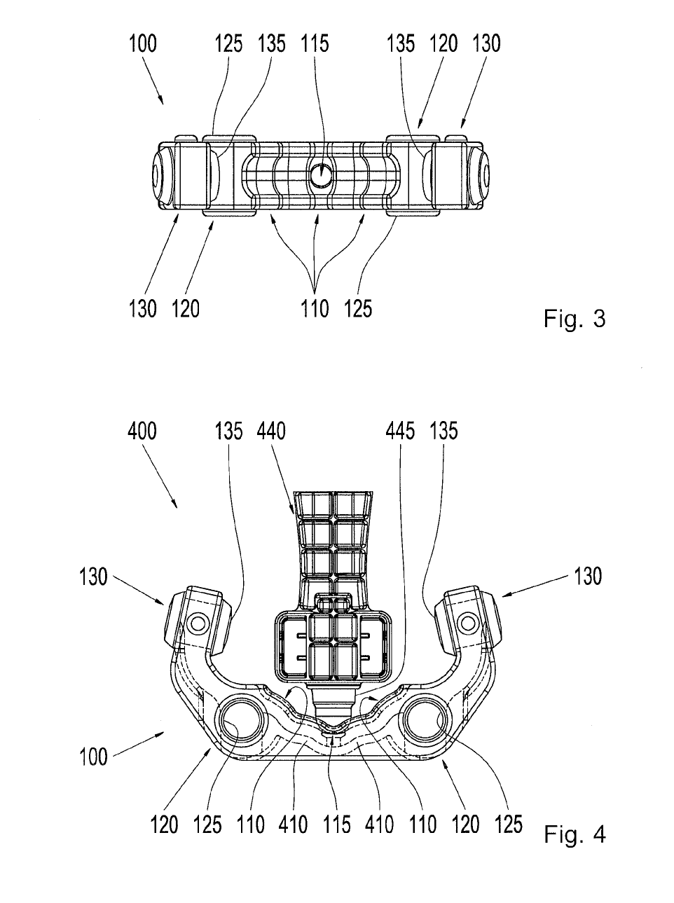

FIG. 3 shows a top view of the device 100 from FIG. 1, respectively FIG. 2. The locking contour 110 with the operating element contact surface 115 arranged centrally in the same can thus be seen.

FIG. 4 shows a sectional view of a shifting device to shift an automatic transmission of a vehicle according to a design example of the present invention. The shifting device has the device for adjusting a movement of an operating element from one of the FIGS. 1 to 3. What is thus shown in FIG. 4 is the device 100, respectively locking device, the locking contour 110, the operating element contact surface 115, the fastening sections 120, the fastening contact surfaces 125, the stop sections 130, the stop contact surfaces 135, the shifting device 400, a soft material section 410, an operating element 440, respectively a gear lever, and a locking element 445. The shifting device 400 comprises the device 100 for adjusting a movement of the operating element 440, as well as the operating element 440 with the locking element.

Even if not shown explicitly in FIG. 4, it can be recognized that the operating element 440 is arranged around a swivel axis with respect to the device 100. The operating element 440 is pivotal, respectively movable along a movement path, whereby different shifting conditions of the automatic transmission are adjustable in dependence of a shift position of the operating element 440. The operating element has the locking element 445.

The locking element 445 is attached spring-mounted on an end of the operating element 440 facing the device 100. The locking element 445 is arranged and shaped to be preloaded in the locking contour 110 of the device 100. In the representation of FIG. 4, the locking element 445 of the operating element 440 is represented attached against the operating element contact surface 115. The operating element 440 is therefore arranged in a shift position arranged to the operating element contact surface 115. The shift position corresponds to a resting position, respectively a center position of the operating element 440. During the movement of the operating element 440 to perform a shifting process, the locking element 445 is movable along the locking element 110 of the device 100.

In FIG. 4, it is furthermore noticeable that the locking contour 110 that is shaped from the hard material, respectively a hard component at least in part spans the soft material section 410 that is arranged internally in the device 100. It can also be noticed in FIG. 4 that the soft material, respectively a soft component of the device 100 is shaped connecting and/ or in one piece. The soft material of the device 100 thus comprises the operating element contact surface 115, the fastening contact surfaces 125, the stop contact surfaces 135, and the soft material section 410.

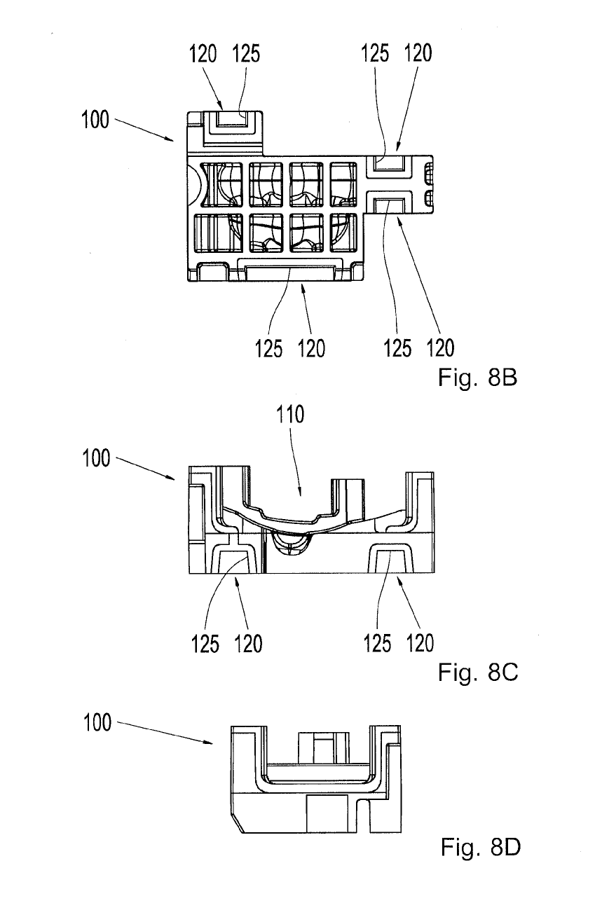

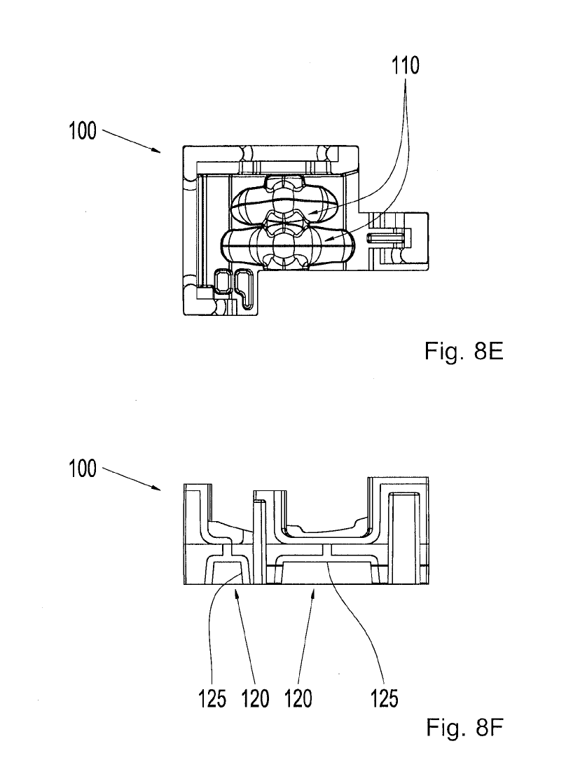

According to one design example, the shifting device 400 can also have the device from FIGS. 8A to 8F as the device 100, even if the shifting device 400 in FIG. 4 is shown with the device from one of the FIGS. 1 to 3.

FIG. 5 shows a sectional view of the shifting device 400 from FIG. 2 in a different shift position. The shift position corresponds to a deviating position of the operating element 440, for example. The representation and the shifting device 400 in FIG. 5 hereby correspond to the representation, respectively the shifting device for FIG. 4 with the exception that the operating element 440 is arranged attached against the stop contact surface 135 drawn on the left in FIG. 5. The locking element 445 of the operating element 440 is represented in the presentation of FIG. 5 arranged attached against an end section of the locking contour 110 of the device 100 drawn on the left in FIG. 5.

FIG. 6 shows a flow chart of a procedure 600 to manufacture a device for adjusting a movement of the operating element for an automatic transmission of a vehicle in accordance with a design example of the present invention. By executing the procedure 600, a device can be manufactured for adjusting a movement of the operating element for an automatic transmission of a vehicle just like the device from one of the FIGS. 1 to 5, respectively 8A to 8F.

The procedure 600 shows a step for shaping a locking contour to define at least one shift position of the operating element along a movement path of the operating element at least partially from a hard material with a first elasticity. The procedure 600 also shows a step 620 for shaping a contact surface of the device from a soft material with a second elasticity that is greater than the first elasticity. The steps 610 and 620 of the shaping can hereby be executed sequentially, at least partially synchronously, and/ or repeatedly.

According to one design example, the device is shaped from the soft material in step 620 of shaping the contact surface of an operating contact surface in at least one partial section of the locking contour arranged to at least one shift position of the operating element, a fastening contact surface of at least one fastening section for attaching the device to a support device by means of a fastening element, or alternately for the mechanical limiting of the operating element along the movement path. According to one design example, steps 610 and 620 of the shaping are performed by executing a two-component injection molding process.

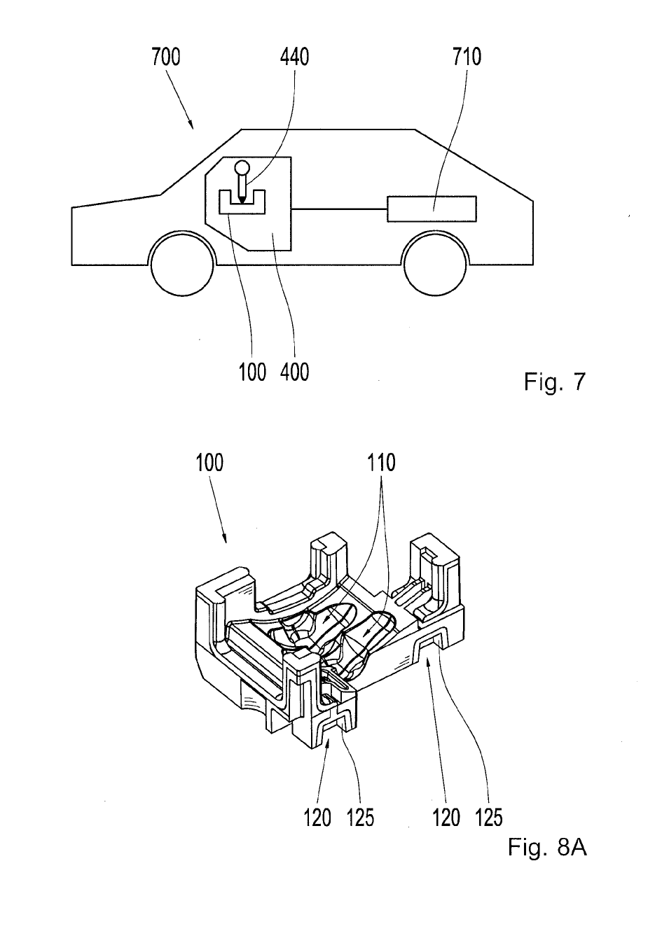

FIG. 7 shows a schematic representation of a vehicle 700 with a shifting device 400 for shifting an automatic transmission 710 of the vehicle 700 according to a design example of the present invention. According to this design example, the shifting device 400 comprises the device 100 described using FIGS. 1 to 3, respectively FIGS. 8A to 8F for adjusting a movement of an operating element 440 of the shifting device 400. The shifting device 400 can be the shifting device from FIG. 4, respectively FIG. 5.

The vehicle 700 comprises the automatic transmission 710 and the shifting device 400. The shifting device 400 is thereby shaped for the shifting of the automatic transmission 710 of the vehicle 700. The automatic transmission 710 is connected with the shifting device 400 capable for signal transmission. The shifting device 400 comprises the device 100 as well as the operating element 440.

FIGS. 8A to 8F show representations of a device 100 for adjusting a movement of an operating element for an automatic transmission of a vehicle in accordance with another design example of the present invention. The device 100 shown in FIGS. 8A to 8F hereby resembles the device from one of the FIGS. 1 to 5, whereby the device 100 in FIGS. 8A to 8F, different from the device from one of the FIGS. 1 to 5, has a locking contour 110 with two longitudinal troughs as well as a multitude of fastening sections 120 in the form of recessed areas with fastening contact surfaces 125. The device 100 in FIGS. 8A to 8F is also represented without the operating element contact surface, stop sections, and stop contact surfaces.

The locking contour 110 with the two longitudinal troughs, the fastening sections 120, and the fastening contact surfaces 125 are thus represented in the execution example of the present invention of the device 100 shown in FIGS. 8A to 8F. The two longitudinal troughs of the locking contour 110 are shaped in parallel to each other within the manufacturing tolerance. A joint partition wall is shaped between the two longitudinal troughs. The locking contour 110 furthermore has a transition section, in which the joint transition wall is open. The transition section is shaped to enable a transitional movement of the operating element from one trough to the other trough.

The two longitudinal troughs of the locking contour 110 are intended for a shifting device, in which the operating element is moveable along a first motion axis, a second motion axis offset along the first motion axis in reference to the first motion axis, as well as a third motion axis running transversely to the first motion axis and the second motion axis. A first of the two longitudinal troughs 110 of the locking contour is assigned to a movement of the operating element along the first motion axis. A second of the two longitudinal troughs of the locking contour 110 is assigned to a movement of the operating element along the second motion axis. The transition section of the locking contour 110 is assigned to a movement of the operating element along the third movement axis.

The first motion axis of the operating element hereby corresponds to a conventional automatic transmission shifting gate with the shift positions P, R, N, and D, the second motion axis corresponds to a so-called manual gate, and the third motion axis corresponds to a connecting gate between the automatic transmission shifting gate and the manual gate, for example.

An isometric view of the device 100 is shown in FIG. 8A, whereby the locking contour 110 can be recognized slanted from above, and where two of the fastening sections 120 can be recognized with the assigned fastening contact surfaces 125 by way of depiction. FIG. 8B shows a bottom view of the device 100 from FIG. 8A, whereby four of the fastening sections 120 with the assigned fastening contact surfaces 125 can be recognized by way of depiction. FIG. 8C shows a front view of the device 100 from FIG. 8A, whereby the locking contour 100 can be recognized from the side, and two of the fastening sections 120 with the assigned fastening contact surfaces 125 can be recognized by way of depiction. FIG. 8D shows a left view of the device 100 from FIG. 8A. FIG. 8E shows a top view of the device 100 from Fig. A, whereby the locking contour 110 can be recognized from the top by way of depiction. FIG. 8F shows another front view of the device 100 from FIG. 8A, whereby two of the fastening sections 120 with the assigned fastening contact surfaces 125 can be recognized by way of depiction.

The execution examples described and shown in the Figures are only selected by way of example. Different design examples can be combined with each other completely or in relation to individual characteristics. A design example can also be supplemented by characteristic of another design example. Procedural steps per the invention may furthermore be listed repeatedly, and also be implemented in a sequence different than described.

If an execution comprises an “and/ or” connection between a first feature and a second feature, then it can be read by that the execution example according to one design example comprises both the first characteristic and also the second characteristic and according to another design example, either comprises only the first characteristic or only the second characteristic.

### REFERENCE SIGNS

100 Device for adjusting, respectively locking device
110 Locking contour
115 Operating element contact surface
120 Fastening section
125 Fastening contact surface
130 Stop section, respectively stop damper
135 Stop contact surface
400 Shifting device
410 Soft material section
440 Operating element
445 Locking element
600 Method for producing
610 Step for shaping a locking contour
620 Step for shaping a contact surface
700 Vehicle
710 Automatic transmission

1. A device for adjusting a movement of an operating element for an automatic transmission of a vehicle, the device comprising:
a locking contour for defining at least one shift position of the operating element along a movement path of the operating element; and
a contact surface;
wherein the locking contour is shaped at least partially from a hard material with a first elasticity;
wherein the contact surface is formed from a soft material with a second elasticity; and
wherein the second elasticity of the soft material is greater than the first elasticity of the hard material.

2. The device of claim 1, wherein the contact surface comprises an operating element contact surface in at least one partial section of the locking contour assigned to at least one shift position of the operating element.

3. The device of claim 1, wherein the device comprises a soft material section shaped from the soft material, and the locking contour that is at least partially shaped from the hard material is shaped spanning the soft material section.

4. The device of claim 1, wherein the device further comprises at least one fastening section to fasten the device to a support device by means of a fastening element, and wherein the contact surface comprises a fastening contact surface of the at least one fastening section.

5. The device of claim 1, wherein the device further comprises at least one stop section for the mechanical limiting of a movement of the operating element along the motion path, and wherein the contact surface comprises a stop contact surface of the at least one stop section.

6. The device of claim 1, wherein the device further comprises an area comprising the soft material is shaped connecting and/or in one piece.

7. A shifting device for shifting an automatic transmission of a vehicle, the shifting device comprising:
an operating element with a locking device;
a device for adjusting a movement of the operating element;
wherein the device comprises a locking contour for defining at least one shift position of the operating element along a movement path of the operating element;
wherein the locking element of the operating element is arranged movable along the locking contour of the device when moving the operating element.

8. A method for manufacturing a device for adjusting a movement of the operating element for an automatic transmission of a vehicle, the method comprising:
shaping of a locking contour for defining at least one shift position of the operating element along a motion path of the operating element, at least partially from a hard material with a first elasticity; and
shaping of a contact surface, of the device from a soft material with a second elasticity that is greater than the first elasticity.

9. The method of claim 8, wherein the shaping of the contact surface comprises an operating element contact surface in a partial section of the locking contour assigned in at least one shift position of the operating element, a fastening contact section of at least one fastening section for fastening the device to a support device by means of a fastening element and/ or a stop contact surface of at least one stop section for the mechanical limiting of a movement of the operating element is shaped along the motion path from the soft material.

10. The method of claim 8, wherein of the shaping of the locking contour and the shaping of the contact surface are performed by executing the two-component injection molding process.

11. The device of claim 2, wherein the device comprises a soft material section shaped from the soft material, and the locking contour that is at least partially shaped from the hard material is shaped spanning the soft material section.

12. The device of claim 2, wherein the device further comprises at least one fastening section to fasten the device to a support device by means of a fastening element, and wherein the contact surface comprises a fastening contact surface of the at least one fastening section.

13. The device of claim 3, wherein the device further comprises at least one fastening section to fasten the device to a support device by means of a fastening element, and wherein the contact surface comprises a fastening contact surface of the at least one fastening section.

14. The device of claim 2, wherein the device further comprises at least one stop section for the mechanical limiting of a movement of the operating element along the motion path, and wherein the contact surface comprises a stop contact surface of the at least one stop section.

15. The device of claim 3, wherein the device further comprises at least one stop section for the mechanical limiting of a movement of the operating element along the motion path, and wherein the contact surface comprises a stop contact surface of the at least one stop section.

16. The device of claim 4, wherein the device further comprises at least one stop section for the mechanical limiting of a movement of the operating element along the motion path, and wherein the contact surface comprises a stop contact surface of the at least one stop section.

17. The device of claim 2, wherein the device further comprises an area comprising the soft material is shaped connecting and/ or in one piece.

18. The device of claim 3, wherein the device further comprises an area comprising the soft material is shaped connecting and/ or in one piece.

19. The device of claim 4, wherein the device further comprises an area comprising the soft material is shaped connecting and/ or in one piece.

20. The method of claim 9, wherein the shaping of the locking contour and the shaping of the contact surface are performed by executing the two-component injection molding process.
